(19) United States
(12) Patent Application Publication
(10) Pub. No.: US 2024/0026122 A1
(43) Pub. Date: Jan. 25, 2024

(54) Composition Containing Cellulose Ester Polymer With Enhanced Melt Strength Agent

(71) Applicant: Celanese International Corporation, Irving, TX (US)

(72) Inventors: Rongfu Li, Narrows, VA (US); Michael Combs, Shady Spring, WV (US); Ronald Hughes, Narrows, VA (US); Susan Blankenship, Narrows, VA (US)

(21) Appl. No.: 18/356,569

(22) Filed: Jul. 21, 2023

Related U.S. Application Data
(60) Provisional application No. 63/391,079, filed on Jul. 21, 2022.

(51) Int. Cl. C08K 5/098; C08L 1/12; C08K 5/11

(52) U.S. Cl. CPC C08K 5/098; C08L 1/12; C08K 5/11

(57) ABSTRACT

A polymer composition comprising a cellulose ester polymer combined with at least one salt additive. The salt additive can be combined with the cellulose ester polymer in order to decrease the melt flow rate of the polymer and improve melt processing of the polymer for forming molded articles.

### RELATED APPLICATIONS

The present application is based upon and claims priority to U.S. Provisional Patent Application Ser. No. 63/391,079, having a filing date of Jul. 21, 2022, which is incorporated herein by reference.

### BACKGROUND

Each year, the global production of plastics continues to increase. Over one-half of the total amount of plastics produced each year are used to produce plastic bottles, containers, drinking straws, and other single-use items. The discarded, single-use plastic articles, including plastic drinking bottles, are typically not recycled and end up in landfills. In addition, many of these items are not properly disposed of and end up in streams, lakes, and oceans around the world.

In view of the above, those skilled in the art have attempted to produce plastic articles made from biodegradable polymers. Many biodegradable polymers, however, lack the physical properties and characteristics of conventional polymers, such as polypropylene and/or polyethylene terephthalate.

Cellulose esters have been proposed in the past as a replacement to some petroleum-based polymers or plastics. Cellulose esters, for instance, are generally considered environmentally friendly polymers because they are recyclable, degradable and derived from renewable resources, such as wood pulp. Problems have been experienced, however, in melt processing cellulose ester polymers, such as cellulose acetate polymers. The polymer materials are relatively stiff and have relatively poor elongation properties.

In view of the above, a need currently exists for a cellulose ester polymer and/or a cellulose ester polymer composition that has improved melt processing characteristics for forming molded articles with excellent mechanical and physical properties.

### SUMMARY

In general, the present disclosure is directed to a polysaccharide ester polymer composition, particularly a cellulose ester polymer composition, that has improved melt processing properties. The polymer composition of the present disclosure is also well suited to forming molded articles having desired mechanical properties. In addition, the polymer composition of the present disclosure can be formulated to have excellent biodegradable properties.

In one embodiment, the present disclosure is directed to a polymer composition comprising a cellulose ester polymer. The cellulose ester polymer can be present in the composition in an amount greater than about 40% by weight. The cellulose ester polymer is optionally blended with a plasticizer. In accordance with the present disclosure, the polymer composition further contains a salt additive that contributes cationic ions to the polymer composition. The salt additive is present in an amount sufficient to lower a melt flow rate of the polymer composition by greater than about 20% in comparison to an identical polymer composition not containing the salt additive. The salt additive can include a multivalent cation having, for instance, a +2 or a +3 valence state. The salt additive may comprise a metal salt, such as a calcium salt, an iron salt, an aluminum salt, a zinc salt, a cobalt salt, a manganese salt, or a magnesium salt. Without limitation and for exemplary purposes only, the salt additive, for example, can be calcium acetate, calcium hydroxide, magnesium acetate, lime, or mixtures thereof.

The salt additive can be present in the polymer composition in an amount from about 1 ppm to about 10,000 ppm, such as from about 5 ppm to about 1,200 ppm, such as from about 10 ppm to about 800 ppm. In various embodiments, the salt additive can be present in the polymer composition in an amount sufficient to lower the melt flow rate of the composition by greater than about 30%, such as by greater than about 40%, such as greater than about 50%, such as greater than about 60%, such as greater than about 70%, such as greater than about 80%. For example, the melt flow rate of the polymer composition can be less than about 20 g/10 min, such as less than about 18 g/10 min, such as less than about 15 g/10 min, such as less than about 12 g/10 min, such as less than about 10 g/10 min, such as less than about 8 g/10 min, when tested at 210° C. and at a load of 2.16 kg.

In one embodiment, the cellulose ester polymer contained in the polymer composition can have a relatively high initial melt flow rate that is then reduced when combined with the salt additive. Although unknown, it is believed that the salt additive may cause ionic crosslinking of the cellulose ester polymer, which causes the melt flow rate to increase. In one particular embodiment, the cellulose ester polymer has an acetyl value of from about 48% to about 56%, such as greater than 50% to less than 54%, such as less than 53%.

In addition to lowering the melt flow rate, the salt additive can also offer various other benefits and advantages. For example, in one embodiment, the salt additive can be present in the polymer composition in an amount sufficient to lower an L* value of an article formed from the polymer composition.

In one aspect, the cellulose ester polymer can be present in the polymer composition in an amount from about 55% by weight to about 95% by weight and the plasticizer can be present in an amount from about 5% by weight to about 40% by weight. Plasticizers that can be incorporated into the polymer composition include tris(clorisopropyl) phosphate, tris(2-chloro-1-methylethyl) phosphate, glycerin, monoacetin, triethyl citrate, acetyl triethyl citrate, a phthalate, an adipate, polyethylene glycol, triacetin, diacetin, trimethyl phosphate, triethyl phosphate, tributyl phosphate, triphenyl phosphate, tributyl-o-acetyl citrate, dibutyl tartrate, ethyl o-benzoylbenzoate, n-ethyltoluenesulfonamide, o-cresyl p-toluenesulfonate, aromatic diol, a substituted aromatic diol, a polycaprolactone diol, an aromatic ether, tripropionin, tribenzoin, glycerin esters, glycerol tribenzoate, glycerol acetate benzoate, polyethylene glycol, a polyethylene glycol ester, a polyethylene glycol diester, di-2-ethylhexyl polyethylene glycol ester, a glycerol ester, diethylene glycol, polypropylene glycol, a polyglycoldiglycidyl ether, dimethyl sulfoxide, N-methyl pyrollidinone, propylene carbonate, a C1-C20 dicarboxylic acid ester, di-butyl maleate, di-octyl maleate, resorcinol monoacetate, catechol, catechol esters, phenols, epoxidized soy bean oil, castor oil, linseed oil, epoxidized linseed oil, difunctional glycidyl ether based on polyethylene glycol, an alkyl lactone, a phospholipid, 2-phenoxyethanol, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, glyceryl tribenzoate, neopentyl dibenzoate, triethylene glycol dibenzoate, trimethylolethane tribenzoate, butylated hydroxytoluene, butylated hydroxyanisol, sorbitol, xylitol, ethylene diamine, piperidine, piperazine, hexamethylene diamine, triazine, triazole, pyrrole, and mixtures thereof.

In one aspect, the plasticizer contained in the polymer composition is triacetin, polyethylene glycol, polycaprolactone diol or mixtures thereof. The cellulose ester polymer, in one aspect, can consist essentially of cellulose diacetate.

The cellulose ester polymer composition may also contain various other additives and components. For instance, the composition can further comprise an antioxidant, a stabilizer, an organic acid, an oil, filler particles, glass fibers, a bio-based polymer other than the cellulose ester, a biodegradable enhancer, a foaming agent, or mixtures thereof. The composition can also contain a mineral filler, such as talc, calcium carbonate, a metal oxide, mica, or mixtures thereof. The polymer composition can also contain a coloring agent which can be a dye, a pigment, or mixtures thereof.

In one embodiment, the polymer composition is combined in a heated extruder or mixer and then extruded into strands that can then be cut into pellets. The pellets can then be used to produce various different molded articles. As an example, the polymer composition can be used to produce beverage holders, drinking straws, hot beverage pods, interior automotive parts, consumer appliance parts, medical device components, packaging and the like.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of a drinking straw that may be made in accordance with the present disclosure;

FIG. 2 is a cross-sectional view of a beverage holder that may be made in accordance with the present disclosure;

FIG. 3 is a side view of one embodiment of a beverage pod that can be made in accordance with the present disclosure;

FIG. 4 is a cross-sectional view of a drinking bottle that may be made in accordance with the present disclosure;

FIG. 5 is a perspective view of an automotive interior illustrating various articles that may be made in accordance with the present disclosure;

FIG. 6 is a perspective view of cutlery made in accordance with the present disclosure;

FIG. 7 is a perspective view of a lid made in accordance with the present disclosure;

FIG. 8 is a perspective view of a container made in accordance with the present disclosure;

FIG. 9 illustrates one embodiment of a medical apparatus comprising a composition prepared according to the present disclosure;

FIG. 10 illustrates another embodiment of a medical apparatus comprising a composition prepared according to the present disclosure;

FIG. 11 illustrates still another embodiment of a medical apparatus comprising a composition prepared according to the present disclosure; and

FIG. 12 illustrates another embodiment of a medical apparatus comprising a composition prepared according to the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to polymer compositions containing a polysaccharide ester polymer, such as a cellulose ester polymer, with improved melt processing properties. Molded articles made from the polymer composition may possess improved physical properties. In addition, the polymer composition of the present disclosure can be formulated to have enhanced sustainability and have a faster biodegradable rate than conventional cellulose ester polymer products. The polymer composition can be used to form all different types of products using any suitable molding technique, such as extrusion, injection molding, and the like. The polymer composition of the present disclosure is particularly well formulated for use in any of the processes described above.

In one aspect, the polymer composition of the present disclosure is directed to a polymer composition containing a cellulose ester polymer having a carefully controlled degree of acetylation in combination with a relatively low melt flow rate or in combination with various other properties. In another aspect, the polymer composition of the present disclosure contains a cellulose ester polymer, such as a cellulose acetate polymer, in combination with a salt additive and optionally a plasticizer. The salt additive of the present disclosure is combined with the cellulose ester polymer in an amount sufficient to lower a melt flow rate of the polymer composition. The salt additive can contribute cationic ions to the polymer composition. Although unknown, it is believed that the salt additive causes ionic crosslinking of the cellulose ester polymer for lowering the melt flow rate.

For example, the salt additive can be combined with the cellulose ester polymer in an amount sufficient to decrease the melt flow rate of the polymer composition and/or the cellulose ester polymer by greater than about 20%, such as greater than about 30%, such as greater than about 40%, such as greater than about 50%, such as greater than about 60%, such as greater than about 70%, such as greater than about 80%. The melt flow rate, for instance, can be lowered by even greater than about 90%, such as by greater than about 95%, and up to about 99.8%.

In general, any suitable cellulose ester polymer can be incorporated into the polymer composition of the present disclosure. In one aspect, the cellulose ester polymer is a cellulose acetate.

Cellulose acetate may be formed by esterifying cellulose after activating the cellulose with acetic acid. The cellulose may be obtained from numerous types of cellulosic material, including but not limited to plant derived biomass, corn stover, sugar cane stalk, bagasse and cane residues, rice and wheat straw, agricultural grasses, hardwood, hardwood pulp, softwood, softwood pulp, cotton linters, switchgrass, bagasse, herbs, recycled paper, waste paper, wood chips, pulp and paper wastes, waste wood, thinned wood, willow, poplar, perennial grasses (e.g., grasses of the Miscanthus family), bacterial cellulose, seed hulls (e.g., soy beans), cornstalk, chaff, and other forms of wood, bamboo, soyhull, bast fibers, such as kenaf, hemp, jute and flax, agricultural residual products, agricultural wastes, excretions of livestock, microbial, algal cellulose, seaweed and all other materials proximately or ultimately derived from plants. Such cellulosic raw materials are preferably processed in pellet, chip, clip, sheet, attritioned fiber, powder form, or other form rendering them suitable for further purification.

Cellulose esters suitable for use in producing the composition of the present disclosure may, in some embodiments, have ester substituents that include, but are not limited to, C1-C20 aliphatic esters (e.g., acetate, propionate, or butyrate), functional C1-C₂₀ aliphatic esters (e.g., succinate, glutarate, maleate) aromatic esters (e.g., benzoate or phthalate), substituted aromatic esters, and the like, any derivative thereof, and any combination thereof.

The cellulose acetate used in the composition may be cellulose diacetate or cellulose triacetate. In one embodiment, the cellulose acetate comprises primarily cellulose diacetate. For example, the cellulose acetate can contain less than 1% by weight cellulose triacetate, such as less than about 0.5% by weight cellulose triacetate. Cellulose diacetate can make up greater than 90% by weight of the cellulose acetate, such as greater than about 95% by weight, such as greater than about 98% by weight, such as greater than about 99% by weight of the cellulose acetate.

In general, the cellulose acetate can have a molecular weight of greater than about 10,000 g/mol, such as greater than about 20,000 g/mol, such as greater than about 30,000 g/mol, such as greater than about 40,000 g/mol, such as greater than about 50,000 g/mol. The molecular weight of the cellulose acetate is generally less than about 800,000 g/mol, such as less than about 600,000 g/mol, such as less than about 200,000 g/mol, such as less than about 150,000 g/mol, such as less than about 100,000 g/mol, such as less than about 90,000 g/mol, such as less than about 70,000 g/mol, such as less than about 50,000 g/mol. The molecular weights identified above refer to the number average molecular weight. Molecular weight can be determined using gel permeation chromatography using a polystyrene equivalent or standard.

The cellulose ester polymer or cellulose acetate can have an initial intrinsic viscosity of generally of from about 0.2 dL/g to about 2 dL/g, including all increments of 0.1 dL/g therebetween.

Intrinsic viscosity may be measured by forming a solution of 0.20 g/dL cellulose ester in 98/2 wt/wt acetone/water and measuring the flow times of the solution and the solvent at 30° C. in a #25 Cannon-Ubbelohde viscometer. Then, the modified Baker-Philippoff equation may be used to determine intrinsic viscosity (“IV”), which for this solvent system is Equation 1.

$$IV = ( \frac{k}{c} ) ( anti log ( ( log {n}_{ret} ) / k ) - 1 ) where {n}_{rel} = ( \frac{{t}_{1}}{{t}_{2}} ) , \qquad Equation 1$$

t₁=the average flow time of solution (having cellulose ester) in seconds, t₂=the average flow times of solvent in seconds, k=solvent constant (10 for 98/2 wt/wt acetone/water), and c=concentration (0.200 g/dL).

The cellulose ester polymer contained in the polymer composition can be characterized by its acetyl value or acetylation degree, which is measured in percent. The acetyl value relates to the degree of substitution and provides information regarding the amount of acetic acid that is released from the cellulose ester polymer by saponification. Acetyl value can be measured according to ASTM Test D871-96 (2004). In one embodiment, ASTM Test D871-96 can be modified by substituting acetic acid (60 molecular weight) for acetyl (42 molecular weight) in calculating the acetyl value.

In general, the cellulose ester polymer can have an acetyl value of from about 48% to about 68% (percent combined acetic acid), including all increments of 0.1% therebetween. In one aspect, the acetyl value can be greater than about 54%, such as greater than about 55%, such as greater than about 56%, and generally less than about 65%, such as less than about 63%.

In one particular embodiment, the cellulose ester polymer has a relatively low acetyl value. For instance, the cellulose ester polymer can have an acetyl value of greater than about 48%, such as greater than about 49%, such as greater than about 50%, such as greater than about 51%, and less than about 56%, such as less than about 55%, such as less than about 54%, such as less than about 53%. In the past, cellulose ester polymers having a relatively low acetyl value were difficult to melt process and form into molded articles using injection molding, blow molding, and the like. Cellulose ester polymers having a relatively low acetyl value, when combined with a plasticizer, tend to have a very high melt flow rate. The high melt flow rate can produce problems when attempting to not only mold the composition into a product but can also affect the stability of the final product. In accordance with the present disclosure, however, cellulose ester polymers having a relatively low acetyl value can be combined with a salt additive in order to significantly and dramatically lower the melt flow rate without compromising any other properties of the cellulose ester polymer or of products made from the polymer composition. In fact, products made with a cellulose ester polymer having a relatively low acetyl value in accordance with the present disclosure can biodegrade more rapidly in comparison to products made from cellulose ester polymers having a higher acetyl value.

In one particular embodiment, for instance, a polymer composition containing a cellulose ester polymer having a relatively low acetyl value as described above and combined with a plasticizer in an amount from about 5% to about 40% by weight, such as in an amount from about 12% to about 28% by weight, can have a melt flow rate of less than about 20 g/10 min, such as less than about 18 g/10 min, such as less than about 15 g/10 min, such as less than about 12 g/10 min, such as less than about 10 g/10 min, such as less than about 8 g/10 min, when tested at 210° C. and at a load of 2.16 kg. As used herein, the melt flow rate is determined according to ASTM Test D1238-13 at a temperature of 210° C. and at a load of 2.16 kg unless indicated otherwise.

Other cellulose ester polymer compositions formulated in accordance with the present disclosure can also have a melt flow rate of less than about 20 g/10 min, such as less than about 18 g/10 min, such as less than about 15 g/10 min, such as less than about 12 g/10 min, such as less than about 10 g/10 min, such as less than about 8 g/10 min, such as less than about 6 g/10 min, such as less than about 4 g/10 min, such as less than about 2 g/10 min when tested at 210° C. and at a load of 2.16 kg.

In general, the cellulose ester polymer is present in the polymer composition in an amount from about 15% by weight to about 95% by weight, including all increments of 1% by weight therebetween. The cellulose acetate is generally present in the polymer composition in an amount greater than about 15% by weight, such as in an amount greater than about 25% by weight, such as in an amount greater than about 35% by weight, such as in an amount greater than about 45% by weight, such as in an amount greater than about 55% by weight, such as in an amount greater than about 65% by weight, such as in an amount greater than about 75% by weight, such as in an amount greater than about 85% by weight. The cellulose acetate is generally present in the polymer composition in an amount less than about 90% by weight, such as in an amount less than about 85% by weight, such as in an amount less than about 75% by weight, such as in an amount less than about 70% by weight, such as in an amount less than about 65% by weight.

In accordance with the present disclosure, the polysaccharide ester polymer or cellulose ester polymer is combined with at least one salt additive. As described above, the salt additive can be added to the polymer composition in an amount sufficient to cause the melt flow rate of the composition to decrease. The salt additive may also affect various other properties of the polymer composition or of molded articles made from the composition. For instance, it is believed that combining the cellulose ester polymer with the salt additive can also increase mechanical strength, such as tensile strength and modulus. It is believed that the addition of the salt additive can also increase the deflection temperature (DTUL) of the polymer composition.

In one aspect, the salt additive contained in the polymer composition is a salt capable of providing cationic ions for combining with the cellulose ester polymer. In one embodiment, the salt additive comprises a salt having a +2 or a +3 cation. The salt additive, in one embodiment, can be a metal salt. The salt additive, for instance, can be a magnesium salt, a calcium salt, an iron salt, an aluminum salt, a zinc salt, a cobalt salt, or a manganese salt. In one aspect, the salt additive is water soluble at 25° C. or at least partially disassociates in water. The salt additive can be an inorganic salt or an organic salt. As used herein, a water soluble solute is soluble in water if more than 1 gram can be dissolved in 100 mL of water at 25° C.

Examples of salt additives that may be used in accordance with the present disclosure include calcium acetate, ferrous acetate, ferric acetate, magnesium acetate, zinc acetate, cobalt acetate, manganese acetate, calcium hydroxide, magnesium hydroxide, lime, or mixtures thereof. Other examples of calcium salts that may be used include calcium sulfate, calcium bicarbonate, calcium bromate, calcium bromide, calcium chloride, calcium nitrate, calcium perchlorate, calcium propionate, calcium carboxylate salts, calcium benzoate, calcium aromatic carboxylate salts, magnesium acetate, magnesium bromide, magnesium chlorate, magnesium nitrate, magnesium perchlorate, magnesium sulfate, magnesium thiosulfate, calcium citrate, calcium gluconate, calcium lactate, zinc acetate, cobalt acetate, manganese acetate, and the like. Any combinations of the above salts can also be used.

In one embodiment, the salt additive has a neutral to acidic pH. For instance, the salt additive can have a pH of less than 8, such as less than about 7.5, such as less than about 7, and greater than about 5, such as greater than about 5.5, such as greater than about 6, such as greater than about 6.5 when combined with water.

The amount that the salt additive is incorporated into the polymer composition can depend upon various factors including the type of cellulose ester polymer present and the amount, the type of plasticizer present and the amount, and the particular salt additive selected. In general, one or more salt additives are incorporated into the polymer composition in an amount greater than about 1 ppm, such as in an amount greater than about 5 ppm, such as in an amount greater than about 10 ppm, such as in an amount greater than about 20 ppm, such as in an amount greater than about 30 ppm, such as in an amount greater than about 40 ppm, such as in an amount greater than about 50 ppm, such as in an amount greater than about 75 ppm, such as in an amount greater than about 100 ppm, such as in an amount greater than about 150 ppm, such as in an amount greater than about 200 ppm, such as in an amount greater than about 250 ppm, such as in an amount greater than about 300 ppm, such as in an amount greater than about 350 ppm, such as in an amount greater than about 400 ppm, such as in an amount greater than about 500 ppm. One or more salt additives are generally present in the polymer composition in an amount less than about 10,000 ppm, such as in an amount less than about 8,000 ppm, such as in an amount less than about 6,000 ppm, such as in an amount less than about 4,000 ppm, such as in an amount less than about 2,000 ppm, such as in an amount less than about 1,000 ppm, such as in an amount less than about 800 ppm.

The manner in which the one or more salt additives are incorporated into the polymer composition can also vary depending upon the particular application. In one embodiment, the salt additive can be combined with the cellulose ester polymer first prior to compounding with one or more plasticizers. In another embodiment, one or more salt additives can be combined with the cellulose ester polymer in conjunction with the plasticizer. For example, the one or more salt additives can be added to an extruder through which the different components are extruded.

In one embodiment, an aqueous solution containing the one or more salt additives is combined with the cellulose ester polymer. For example, cellulose ester particles or flakes can be contacted with the aqueous solution containing the one or more salt additives. Alternatively, the aqueous solution containing the one or more salt additives can be added to an extruder during extrusion. The aqueous solution can contain one or more salt additives generally in an amount from about 50 ppm to about 50,000 ppm, including all increments of 1 ppm therebetween. For instance, the aqueous solution can contain one or more salt additives at a concentration of from about 50 ppm to about 2,000 ppm in one embodiment. In an alternative embodiment, a greater concentration of one or more salt additives can be incorporated into the aqueous solution, such as in an amount from about 2,000 ppm to about 20,000 ppm. When applied to the cellulose ester polymer in the form of an aqueous solution, the amount of salt additive incorporated into the resulting polymer composition is generally less than the concentration contained within the aqueous solution.

The polymer composition of the present disclosure can optionally include one or more plasticizers. Plasticizers particularly well suited for use in the polymer composition include triacetin, monoacetin, diacetin, and mixtures thereof. Other suitable plasticizers include tris(clorisopropyl) phosphate, tris(2-chloro-1-methylethyl) phosphate, triethyl citrate, acetyl triethyl citrate, glycerin, or mixtures thereof. In an alternative embodiment, the plasticizer can be a polyethylene glycol. In still another embodiment, the plasticizer can be a polycaprolactone.

Other examples of plasticizers include, but are not limited to, trimethyl phosphate, triethyl phosphate, tributyl phosphate, triphenyl phosphate, acetyl tributyl citrate, tributyl-o-acetyl citrate, dibutyl tartrate, ethyl o-benzoylbenzoate, n-ethyltoluenesulfonamide, o-cresyl p-toluenesulfonate, aromatic diol, substituted aromatic diols, aromatic ethers, tripropionin, tribenzoin, glycerin, glycerin esters, glycerol tribenzoate, glycerol acetate benzoate, polyethylene glycol esters, polyethylene glycol diesters, di-2-ethylhexyl polyethylene glycol ester, glycerol esters, diethylene glycol, polypropylene glycol, polyglycoldiglycidyl ethers, dimethyl sulfoxide, N-methyl pyrollidinone, propylene carbonate, C1-C20 dicarboxylic acid esters, dimethyl adipate (and other dialkyl esters), di-butyl maleate, di-octyl maleate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkyl lactones (e.g., .gamma.-valerolactone), alkylphosphate esters, aryl phosphate esters, phospholipids, aromas (including some described herein, e.g., eugenol, cinnamyl alcohol, camphor, methoxy hydroxy acetophenone (acetovanillone), vanillin, and ethylvanillin), 2-phenoxyethanol, glycol ethers, glycol esters, glycol ester ethers, polyglycol ethers, polyglycol esters, ethylene glycol ethers, propylene glycol ethers, ethylene glycol esters (e.g., ethylene glycol diacetate), propylene glycol esters, polypropylene glycol esters, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, glyceryl tribenzoate, neopentyl dibenzoate, triethylene glycol dibenzoate, trimethylolethane tribenzoate, butylated hydroxytoluene, butylated hydroxyanisol, sorbitol, xylitol, ethylene diamine, piperidine, piperazine, hexamethylene diamine, triazine, triazole, pyrrole, polycaprolactone diol and the like, any derivative thereof, and any combination thereof.

In one aspect, a carbonate ester may serve as a plasticizer. Exemplary carbonate esters may include, but are not limited to, propylene carbonate, butylene carbonate, diphenyl carbonate, phenyl methyl carbonate, dicresyl carbonate, glycerin carbonate, dimethyl carbonate, diethyl carbonate, ethylene carbonate, propylene carbonate, isopropylphenyl 2-ethylhexyl carbonate, phenyl 2-ethylhexyl carbonate, isopropylphenyl isodecyl carbonate, isopropylphenyl tridecyl carbonate, phenyl tridecyl carbonate, and the like, and any combination thereof.

In still another aspect, the plasticizer can be a polyol benzoate. Exemplary polyol benzoates may include, but are not limited to, glyceryl tribenzoate, propylene glycol dibenzoate, diethylene glycol dibenzoate, dipropylene glycol dibenzoate, triethylene glycol dibenzoate, sucrose benzoate, polyethylene glycol dibenzoate, neopentylglycol dibenzoate, trimethylolpropane tribenzoate, trimethylolethane tribenzoate, pentaerythritol tetrabenzoate, sucrose benzoate (with a degree of substitution of 1-8), and combinations thereof. In some instances, tribenzoates like glyceryl tribenzoate may be preferred. In some instances, polyol benzoates may be solids at 25° C. and a water solubility of less than 0.05 g/100 mL at 25° C.

The plasticizer can also be bio-based. For example, using a bio-based plasticizer can render the polymer composition well suited for contact with food items. Bio-based plasticizers particularly well suited for use in the composition of the present disclosure include an alkyl ketal ester, a non-petroleum hydrocarbon ester, a bio-based polymer or oligomer, such as polycaprolactone, having a number average molecular weight of 1000 or less, or mixtures thereof.

In one aspect, the bio-based plasticizer is an alkyl ketal ester having a chemical structure corresponding to Structure I as provided below:

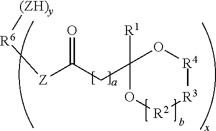

wherein a is from 0 to 12; b is 0 or 1; each R¹ is independently hydrogen, a hydrocarbyl group, or a substituted hydrocarbyl group; each R², R³, and R⁴ are independently methylene, alkylmethylene, or dialkylmethylene, x is at least 1, y is 0 or a positive number and x+y is at least 2; R⁶ is a hydrocarbyl group or a substituted hydrocarbyl group and each Z is independently —O—, —NH— or —NR— where R is a hydrocarbyl group or a substituted hydrocarbyl group.

The plasticizer identified above corresponds to a reaction product of a polyol, aminoalcohol or polyamine and certain 1,2- and/or 1,3-alkanediol ketal of an oxocarboxylate esters. 1,2- and 1,3-alkanediols ketals of oxocarboxylate esters are referred to herein as “alkyl ketal esters”. Up to one mole of alkyl ketal ester can be reacted per equivalent of hydroxyl groups or amino groups provided by the polyol, aminoalcohol or polyamine. The polyol, aminoalcohol or polyamine is most preferably difunctional, but polyols, aminoalcohols and polyamines having more than two hydroxyl and/or amino groups can be used.

The values of x and y in structure I will depend on the number of hydroxyl groups or amino groups on the polyol, aminoalcohol or polyamine, the number of moles of the alkyl ketal ester per mole of the polyol, aminoalcohol or polyamine, and the extent to which the reaction is taken towards completion. Higher amounts of the alkyl ketal ester favor lower values for y and higher values of x.

In structure I, y is specifically from 0 to 2 and x is specifically at least 2. All a in structure I are specifically 2 to 12, more specifically, 2 to 10, more specifically, 2 to 8, more specifically, 2 to 6, more specifically, 2 to 4, and more specifically, 2. All R¹ are specifically an alkyl group, specifically methyl. In some embodiments of structure I, all Z are —O—, y is 0 and x is 2; these products correspond to a reaction of two moles of an alkyl ketal ester and one mole of a diol. In some other embodiments, all Z are —O—, y is 1 and x is 1; these products correspond to the reaction of one mole of the alkyl ketal ester and one mole of a diol.

In one embodiment, all b are 0. In another embodiment, all b are 1.

Some specific compounds according to structure I include those having the structure:

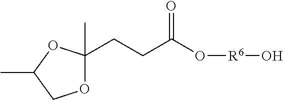

or the structure

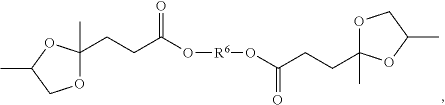

or the structure

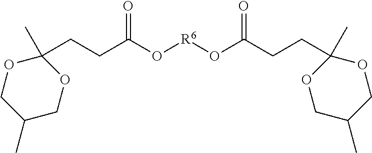

particularly in which R⁶ is —(CH₂)—ₘ wherein m is from 2 to 18, especially 2, 3, 4 or 6. In one specific embodiment, R⁶ corresponds to the residue, after removal of hydroxyl groups, of 1,4-butane diol resulting in the structure (la)

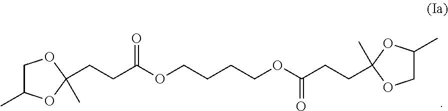

In another specific embodiment, R⁶ corresponds to the residue, after removal of hydroxyl groups, of diethylene glycol resulting in structure (Ib)

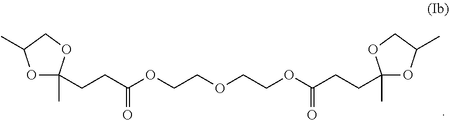

In another specific embodiment, R⁶ corresponds to the residue, after removal of hydroxyl groups, of 2-methyl. 1-3 propane diol resulting in structure (Ic)

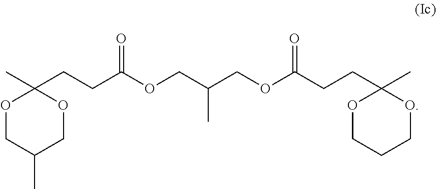 [SMILES: CC(COC(=O)CCC1(C)OCCCO1)COC(=O)CCC1(C)OCC(C)CO1]

Compounds according to structure I can be prepared in a transesterification or ester-aminolysis reaction between the corresponding polyol, aminoalcohol or polyamine and the corresponding alkyl ketal ester. Alternatively, compounds according to structure I can be prepared by reacting an oxocarboxylic acid with the polyol, aminoalcohol or polyamine to form an ester or amide, and then ketalizing the resulting product with a 1,2- or 1,3-alkane diol such as ethylene glycol, 1,2-propanediol, 1,3-propanediol, 2-methyl, 1-3 propane diol, 1,2-butanediol, 1,3-butanediol, 1,2-pentanediol, 1,3-pentanediol, 1,2-hexanediol, 1,3-hexanediol, polycaprolactone diol and the like.

Alkyl ketal ester plasticizers are particularly well suited for use in conjunction with one or more other plasticizers. For example, in one aspect, an alkyl ketal ester plasticizer can be combined with a benzoate ester. The weight ratio between the two plasticizers can vary such as from about 1:10 to about 10:1, such as from about 1:4 to about 4:1.

Another bio-based plasticizer that may be incorporated into the polymer composition of the present disclosure is a non-petroleum hydrocarbon ester. For example, one example of a non-petroleum hydrocarbon ester is sold under the tradename HALLGREEN by the Hall Star Company of Chicago, Illinois. Non-petroleum hydrocarbon ester plasticizers, for instance, can contain greater than about 50% by weight, such as greater than about 70% by weight, such as greater than about 99% by weight of bio-based content. The esters, for instance, can be derived primarily from agricultural, forestry, or marine materials and thus are biodegradable. In one aspect, the non-petroleum hydrocarbon ester plasticizer has a specific gravity at 25° C. of about 1.16 or greater, such as about 1.165 or greater, such as about 1.17 or greater, such as about 1.74 or greater, and generally about 1.19 or less, such as about 1.185 or less, such as about 1.18 or less, such as about 1.78 or less. The non-petroleum hydrocarbon ester plasticizer can have an acid value of from about 0.5 mgKOH/g to about 0.6 mgKOH/g, such as from about 0.53 mgKOH/g to about 0.57 mgKOH/g.

In another aspect, the polymer composition contains a bio-based plasticizer that is a bio-based polyester, such as a bio-based aliphatic polyester having a relatively low molecular weight. For example, the plasticizer can comprise a bio-based polyester polymer having a number average molecular weight of less than about 1000, such as less than about 900, such as less than about 800, and generally greater than about 500. In one embodiment, the bio-based plasticizer is a polycaprolactone having a number average molecular weight of 1000 or less. Alternatively, the bio-based plasticizer may be a polyhydroxyalkanoate, such as a polyhydroxybutyrate, having a number average molecular weight of 10,000 or less.

In one aspect, the plasticizer is phthalate-free. In fact, the polymer composition can be formulated to be phthalate-free. For instance, phthalates can be present in the polymer composition in an amount of about 0.5% or less, such as in an amount of about 0.1% or less.

In general, one or more plasticizers can be present in the polymer composition in an amount from about 3% to about 40% by weight, such as in an amount from about 8% to about 35% by weight. In the past, however, it was believed that relatively high amounts of plasticizer were needed in order to produce a cellulose acetate composition capable of being melt processed. However, the amount of plasticizer can be reduced without compromising the melt processing characteristics of the composition. For example, in one aspect, one or more plasticizers can be present in the polymer composition in an amount of about 19% or less, such as in an amount of about 17% or less, such as in an amount of about 15% or less, such as in an amount of about 13% or less, such as in an amount of about 10% or less. One or more plasticizers are generally present in an amount from about 3% or greater, such as in an amount of about 5% or greater.

The cellulose acetate can be present in relation to the plasticizer such that the weight ratio between the cellulose acetate and the one or more plasticizers is from about 60:40 to about 95:5, such as from about 70:30 to about 90:10.

In addition to a polysaccharide ester polymer, one or more salt additives, and optionally one or more plasticizers, the polymer composition of the present disclosure can contain various other additives and ingredients. For example, cellulose acetate, the one or more plasticizers and the one or more salt additives can also be combined with one or more bio-based polymers that are different than the cellulose acetate and the one or more plasticizers. As used herein, a “bio-based” polymer or plasticizer refers to a polymer, oligomer, or compound produced from at least partially renewable biomass sources, such as produced from plant matter or food waste. For example, a bio-based polymer can be a polymer produced from greater than 30% renewable resources, such as greater than about 40% renewable resources, such as greater than about 50% renewable resources, such as greater than about 60% renewable resources, such as greater than about 70% renewable resources, such as greater than about 80% renewable resources, such as greater than about 90% renewable resources. Bio-based polymers are to be distinguished from polymers derived from fossil resources such as petroleum. Bio-based polymers can be bio-derived meaning that the polymer originates from a biological source or produced via a biological reaction, such as through fermentation or other microorganism process. Although a cellulose ester polymer can be considered a bio-based polymer, the term herein refers to other bio-based substances that can be combined with cellulose ester polymers. The bio-based polymer can also be biodegradable.

In one aspect, the bio-based polymer can be a polyester polymer, such as an aliphatic polyester. Particular bio-based polymers that may be incorporated into the polymer composition include polyhydroxyalkanoates, polylactic acid, polycaprolactone, or mixtures thereof.

In one aspect, the at least one bio-based polymer combined with the cellulose acetate is a polyhydroxyalkanoate. The polyhydroxyalkanoate can be a homopolymer or a copolymer. Polyhydroxyalkanoates, also known as “PHAs”, are linear polyesters produced in nature by bacterial fermentation of sugar or lipids. More than 100 different monomers can be combined within this family to give materials with extremely different properties. Generally, they can be either thermoplastic or elastomeric materials, with melting-points ranging from 40 to 180° C. The most common type of PHAs is PHB (poly-beta-hydroxybutyrate). Poly(3-hydroxybutyrate) (PHB) is a type of a naturally occurring thermoplastic polymer currently produced microbially inside of the cell wall of a number of wild bacteria species or genetically modified bacteria or yeasts, etc. It is biodegradable and does not present environmental issues post disposal, i.e., articles made from PHB can be composted.

The one or monomers used to produce a PHA can significantly impact the physical properties of the polymer. For example, PHAs can be produced that are crystalline, semi-crystalline, or completely amorphous. For example, poly-4-hydroxybutyrate homopolymer can be completely amorphous with a glass transition temperature of less than about −30° C. and with no noticeable melting point temperature. Polyhydroxybutyrate-valerate copolymers also can be formulated to be semi-crystalline to amorphous having low stiffness characteristics.

Examples of monomer units that can be incorporated in PHAs include 2-hydroxybutyrate, glycolic acid, 3-hydroxybutyrate (hereinafter referred to as 3HB), 3-hydroxypropionate (hereinafter referred to as 3HP), 3-hydroxyvalerate (hereinafter referred to as 3HV), 3-hydroxyhexanoate (hereinafter referred to as 3HH), 3-hydroxyheptanoate (hereinafter referred to as 3HH), 3-hydroxyoctanoate (hereinafter referred to as 3HO), 3-hydroxynonanoate (hereinafter referred to as 3HN), 3-hydroxydecanoate (hereinafter referred to as 3HD), 3-hydroxydodecanoate (hereinafter referred to as 3HDd), 4-hydroxybutyrate (hereinafter referred to as 4HB), 4-hydroxyvalerate (hereinafter referred to as 4HV), 5-hydroxyvalerate (hereinafter referred to as 5HV), and 6-hydroxyhexanoate (hereinafter referred to as 6HH). 3-hydroxyacid monomers incorporated into PHAs are the (D) or (R) 3-hydroxyacid isomer with the exception of 3HP which does not have a chiral center.

In some embodiments, the PHA in the methods described herein is a homopolymer (where all monomer units are the same). Examples of PHA homopolymers include poly 3-hydroxyalkanoates (e.g., poly 3-hydroxypropionate (hereinafter referred to as P3HP)), poly 3-hydroxybutyrate (hereinafter referred to as P3HB) and poly 3-hydroxyvalerate, poly 4-hydroxyalkanoates (e.g., poly 4-hydroxybutyrate (hereinafter referred to as P4HB)), poly 4-hydroxyvalerate (hereinafter referred to as P4HV)) or poly 5-hydroxyalkanoates (e.g., poly 5-hydroxyvalerate (hereinafter referred to as P5HV)).

In certain embodiments, the PHA can be a copolymer (containing two or more different monomer units) in which the different monomers are randomly distributed in the polymer chain. Examples of PHA copolymers include poly 3-hydroxybutyrate-co-3-hydroxypropionate (hereinafter referred to as PHB3HP), poly 3-hydroxybutyrate-co-4-hydroxybutyrate (hereinafter referred to as P3HB4HB), poly 3-hydroxybutyrate-co-4-hydroxyvalerate (hereinafter referred to as PHB4HV), poly 3-hydroxybutyrate-co-3-hydroxyvalerate (hereinafter referred to as PHB3HV), poly 3-hydroxybutyrate-co-3-hydroxyhexanoate (hereinafter referred to as PHB3HH) and poly 3-hydroxybutyrate-co-5-hydroxyvalerate (hereinafter referred to as PHB5HV).

An example of a PHA having 4 different monomer units would be PHB-co-3HH-co-3HO-co-3HD or PHB-co-3-HO-co-3HD-co-3HDd. Typically where the PHB3HX has 3 or more monomer units, the 3HB monomer is at least 70% by weight of the total monomers, such as greater than 90% by weight of the total monomers.

When present, one or more PHAs can be contained in the polymer composition in an amount of about 2% or greater, such as about 3% or greater, such as about 5% or greater, such as about 7% or greater, such as about 10% or greater, such as about 12% or greater, such as about 15% or greater, such as about 18% or greater. One or more PHAs are generally present in the polymer composition in an amount of about 30% or less, such as in an amount of about 25% or less, such as in an amount of about 20% or less, such as in an amount of about 15% or less.

In addition to one or more PHAs, the polymer composition can contain various other bio-based polymers, such as a polylactic acid or a polycaprolactone. Polylactic acid also known as “PLAs” are well suited for combining with one or more PHAs. Polylactic acid polymers are generally stiffer and more rigid than PHAs and thus can be added to the polymer composition for further refining the properties of the overall formulation.

Polylactic acid may generally be derived from monomer units of any isomer of lactic acid, such as levorotory-lactic acid (“L-lactic acid”), dextrorotatory-lactic acid (“D-lactic acid”), meso-lactic acid, or mixtures thereof. Monomer units may also be formed from anhydrides of any isomer of lactic acid, including L-lactide, D-lactide, meso-lactide, or mixtures thereof. Cyclic dimers of such lactic acids and/or lactides may also be employed. Any known polymerization method, such as polycondensation or ring-opening polymerization, may be used to polymerize lactic acid. A small amount of a chain-extending agent (e.g., a diisocyanate compound, an epoxy compound or an acid anhydride) may also be employed. The polylactic acid may be a homopolymer or a copolymer, such as one that contains monomer units derived from L-lactic acid and monomer units derived from D-lactic acid. Although not required, the content of one of the monomer units derived from L-lactic acid and the monomer units derived from D-lactic acid is preferably about 85 mole % or more, in some embodiments about 90 mole % or more, and in some embodiments, about 95 mole % or more. Multiple polylactic acids, each having a different ratio between the monomer unit derived from L-lactic acid and the monomer unit derived from D-lactic acid, may be blended at an arbitrary percentage.

In one particular embodiment, the polylactic acid has the following general structure:

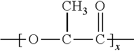

The polylactic acid typically has a number average molecular weight (“Mₙ”) ranging from about 40,000 to about 160,000 grams per mole, in some embodiments from about 50,000 to about 140,000 grams per mole, and in some embodiments, from about 80,000 to about 120,000 grams per mole. Likewise, the polymer also typically has a weight average molecular weight (“M_{w}”) ranging from about 80,000 to about 200,000 grams per mole, in some embodiments from about 100,000 to about 180,000 grams per mole, and in some embodiments, from about 110,000 to about 160,000 grams per mole. The ratio of the weight average molecular weight to the number average molecular weight (“M_{w}/Mₙ”), i.e., the “polydispersity index”, is also relatively low. For example, the polydispersity index typically ranges from about 1.0 to about 3.0, in some embodiments from about 1.1 to about 2.0, and in some embodiments, from about 1.2 to about 1.8. The weight and number average molecular weights may be determined by methods known to those skilled in the art.

Polylactic acid can be present in the polymer composition in an amount of about 1% or greater, such as in an amount of about 3% or greater, such as in an amount of about 5% or greater, and generally in an amount of about 20% or less, such as in an amount of about 15% or less, such as in an amount of about 10% or less, such as in an amount of about 8% or less.

As described above, another bio-based polymer that may be combined with cellulose acetate alone or in conjunction with other bio-based polymers is polycaprolactone having a molecular weight higher than a polycaprolactone plasticizer. Polycaprolactone, similar to PHAs, can be formulated to have a relatively low glass transition temperature. The glass transition temperature, for instance, can be less than about 10° C., such as less than about −5° C., such as less than about −20° C., and generally greater than about −60° C. The polymers can be produced so as to be amorphous or semi-crystalline. The crystallinity of the polymers can be less than about 50%, such as less than about 25%.

Polycaprolactones can be made having a number average molecular weight of generally greater than about 5,000, such as greater than about 8,000, and generally less than about 15,000, such as less than about 12,000.

Polycaprolactones can be contained in the polymer composition in an amount of about 2% or greater, such as about 3% or greater, such as about 5% or greater, such as about 7% or greater, such as about 10% or greater, such as about 12% or greater, such as about 15% or greater, such as about 18% or greater. Polycaprolactones are generally present in the polymer composition in an amount of about 30% or less, such as in an amount of about 25% or less, such as in an amount of about 20% or less, such as in an amount of about 15% or less.

Other bio-based polymers that may be incorporated into the polymer composition include polybutylene succinate, polybutylene adipate terephthalate, a plasticized starch, other starch-based polymers, and the like. In addition, the bio-based polymer can be a polyolefin or polyester polymer made from renewable resources. For example, such polymers include bio-based polyethylene, bio-based polybutylene terephthalate, and the like.

In one aspect, an acid scavenger can also be present in the polymer composition. The acid scavenger can be a carbonate, an oxide, an amine, or mixtures thereof. Examples of acid scavengers include zinc oxide, magnesium oxide, aluminum sodium carbonate, an aluminum silicate, a hydrotalcite, or mixtures thereof. One or more acid scavengers can be present in the polymer composition generally in an amount greater than about 0.1% by weight, such as greater than about 0.5% by weight, such as greater than about 1% by weight, and generally less than about 2.5% by weight, such as less than about 2% by weight, such as less than about 1.5% by weight.

The polymer composition may also contain antioxidants, pigments, lubricants, softening agents, antibacterial agents, antifungal agents, preservatives, flame retardants, and combinations thereof. Each of the above additives can generally be present in the polymer composition in an amount of about 5% or less, such as in an amount of about 2% or less, and generally in an amount of about 0.1% or greater, such as in an amount of about 0.3% or greater.

Flame retardants suitable for use in conjunction with a cellulose ester plastic described herein may, in some embodiments, include, but are not limited to, silica, metal oxides, phosphates, catechol phosphates, resorcinol phosphates, borates, inorganic hydrates, aromatic polyhalides, and the like, and any combination thereof.

Antifungal and/or antibacterial agents suitable for use in conjunction with a cellulose ester plastic described herein may, in some embodiments, include, but are not limited to, polyene antifungals (e.g., natamycin, rimocidin, filipin, nystatin, amphotericin B, candicin, and hamycin), imidazole antifungals such as miconazole (available as MICATIN® from WellSpring Pharmaceutical Corporation), ketoconazole (commercially available as NIZORAL® from McNeil consumer Healthcare), clotrimazole (commercially available as LOTRAMIN® and LOTRAMIN AF® available from Merck and CANESTEN® available from Bayer), econazole, omoconazole, bifonazole, butoconazole, fenticonazole, isoconazole, oxiconazole, sertaconazole (commercially available as ERTACZO® from OrthoDematologics), sulconazole, and tioconazole; triazole antifungals such as fluconazole, itraconazole, isavuconazole, ravuconazole, posaconazole, voriconazole, terconazole, and albaconazole), thiazole antifungals (e.g., abafungin), allylamine antifungals (e.g., terbinafine (commercially available as LAMISIL® from Novartis Consumer Health, Inc.), naftifine (commercially available as NAFTIN® available from Merz Pharmaceuticals), and butenafine (commercially available as LOTRAMIN ULTRA® from Merck), echinocandin antifungals (e.g., anidulafungin, caspofungin, and micafungin), polygodial, benzoic acid, ciclopirox, tolnaftate (e.g., commercially available as TINACTIN® from MDS Consumer Care, Inc.), undecylenic acid, flucytosine, 5-fluorocytosine, griseofulvin, haloprogin, caprylic acid, and any combination thereof.

Preservatives suitable for use in conjunction with a cellulose ester plastic described herein may, in some embodiments, include, but are not limited to, benzoates, parabens (e.g., the propyl-4-hydroxybenzoate series), and the like, and any combination thereof.

Pigments and dyes suitable for use in conjunction with a cellulose ester plastic described herein may, in some embodiments, include, but are not limited to, plant dyes, vegetable dyes, titanium dioxide, silicon dioxide, tartrazine, E102, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, calcium carbonate, kaolin clay, aluminum hydroxide, barium sulfate, zinc oxide, aluminum oxide, CARTASOL® dyes (cationic dyes, available from Clariant Services) in liquid and/or granular form (e.g., CARTASOL® Brilliant Yellow K-6G liquid, CARTASOL® Yellow K-4GL liquid, CARTASOL® Yellow K-GL liquid, CARTASOL® Orange K-3GL liquid, CARTASOL® Scarlet K-2GL liquid, CARTASOL® Red K-3BN liquid, CARTASOL® Blue K-5R liquid, CARTASOL® Blue K-RL liquid, CARTASOL® Turquoise K-RL liquid/granules, CARTASOL® Brown K-BL liquid), FASTUSOL® dyes (an auxochrome, available from BASF) (e.g., Yellow 3GL, Fastusol C Blue 74L), and the like, any derivative thereof, and any combination thereof.

In some embodiments, pigments and dyes suitable for use in conjunction with a cellulose ester plastic described herein may be food-grade pigments and dyes. Examples of food-grade pigments and dyes may, in some embodiments, include, but are not limited to, plant dyes, vegetable dyes, titanium dioxide, and the like, and any combination thereof.

Antioxidants may, in some embodiments, mitigate oxidation and/or chemical degradation of a cellulose ester plastic described herein during storage, transportation, and/or implementation. Antioxidants suitable for use in conjunction with a cellulose ester plastic described herein may, in some embodiments, include, but are not limited to, anthocyanin, ascorbic acid, glutathione, lipoic acid, uric acid, resveratrol, flavonoids, carotenes (e.g., beta-carotene), carotenoids, tocopherols (e.g., alpha-tocopherol, beta-tocopherol, gamma-tocopherol, and delta-tocopherol), tocotrienols, tocopherol esters (e.g., tocopherol acetate), ubiquinol, gallic acids, melatonin, secondary aromatic amines, benzofuranones, hindered phenols, polyphenols, hindered amines, organophosphorus compounds, thioesters, benzoates, lactones, hydroxylamines, butylated hydroxytoluene (“BHT”), butylated hydroxyanisole (“BHA”), hydroquinone, and the like, and any combination thereof.

In some embodiments, antioxidants suitable for use in conjunction with a cellulose ester plastic described herein may be food-grade antioxidants. Examples of food-grade antioxidants may, in some embodiments, include, but are not limited to, ascorbic acid, vitamin A, tocopherols, tocopherol esters, beta-carotene, flavonoids, BHT, BHA, hydroquinone, and the like, and any combination thereof.

In one embodiment, the polymer composition contains an antioxidant comprising a phosphorus compound, particularly a phosphite. For instance, in one embodiment, the antioxidant can be a diphosphite. For example, in one embodiment, the antioxidant is a pentaerythritol diphosphite, such as bis(2,4-dicumylphenyl)pentaerythritol diphosphite. The antioxidant can be present in the polymer composition generally in an amount less than about 2% by weight, such as in an amount less than about 1% by weight, such as in an amount less than about 0.5% by weight, such as in an amount less than about 0.3% by weight. The antioxidant can be present in the polymer composition generally in an amount greater than about 0.05% by weight, such as in an amount greater than about 0.08% by weight, such as in an amount greater than about 0.1% by weight, such as in an amount greater than about 0.13% by weight.

The polymer composition of the present disclosure can be formed into any suitable polymer article using any technique known in the art. For instance, polymer articles can be formed from the polymer composition through extrusion, injection molding, blow molding, and the like.

In one aspect, the polymer composition containing the cellulose acetate can be formulated such that the polymer composition has properties very comparable to petroleum-based polymers, such as polypropylene. By matching the physical properties of a petroleum-based polymer, the polymer composition of the present disclosure is well suited to replacing those polymers in many different end use applications.

Polymer articles that may be made in accordance with the present disclosure include drinking straws, beverage holders, automotive parts, knobs, door handles, consumer appliance parts, and the like.

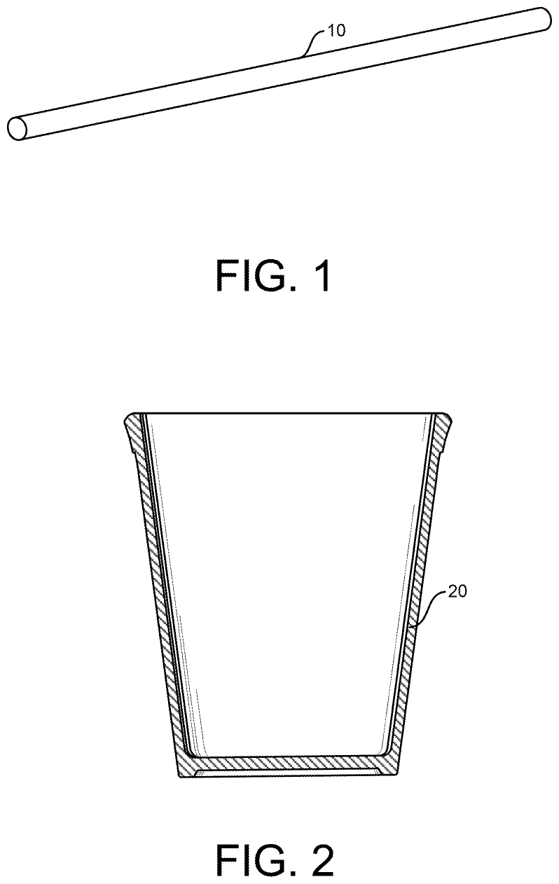

For instance, referring to FIG. 1, a drinking straw 10 is shown that can be made in accordance with the present disclosure. In the past, drinking straws were conventionally made from petroleum-based polymers, such as polypropylene. The cellulose acetate polymer composition of the present disclosure, however, can be formulated so as to match the physical properties of polypropylene. Thus, drinking straws 10 can be produced in accordance with the present disclosure and be completely biodegradable.

Referring to FIG. 2, a cup or beverage holder 20 is shown that can also be made in accordance with the present disclosure. The cup 20 can be made, for instance, using injection molding or through any suitable thermoforming process. As shown in FIG. 7, a lid 22 for the cup 20 can also be made from the polymer composition of the present disclosure. The lid can include a pour spout 24 for dispensing a beverage from the cup 20. In addition to lids for beverage holders, the polymer composition of the present disclosure can be used to make lids for all different types of containers, including food containers, package containers, storage containers and the like.

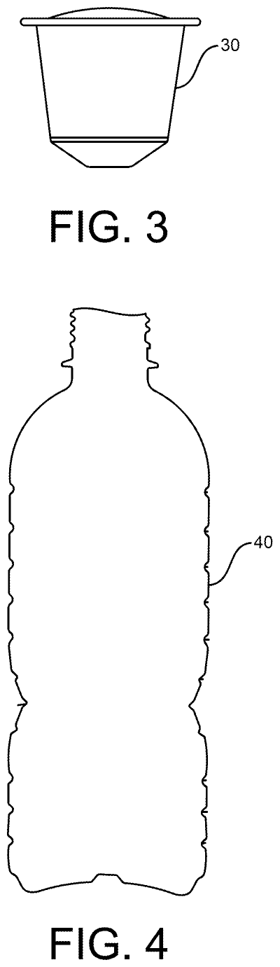

In still another embodiment, the polymer composition can be used to produce a hot beverage pod 30 as shown in FIG. 3. In addition to the beverage pod 30, the polymer composition can also be used to produce a plastic bottle 40 as shown in FIG. 4, which can serve as a water bottle or other sport drink container.

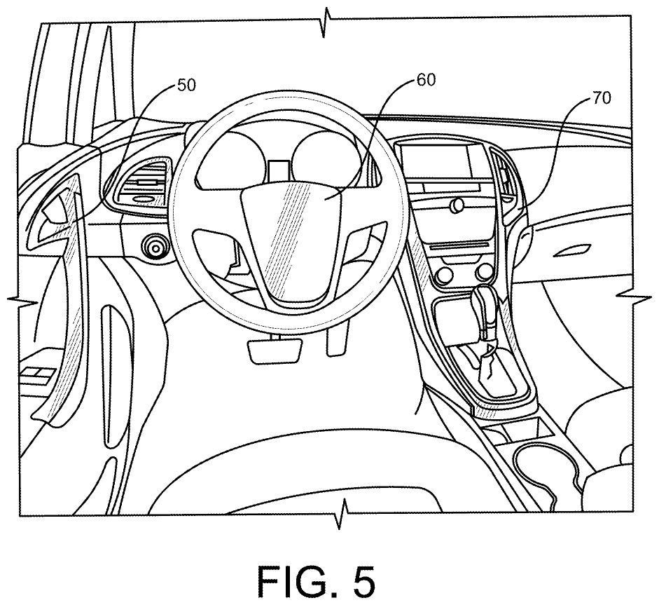

Referring to FIG. 5, an automotive interior is illustrated. The automotive interior includes various automotive parts that may be made in accordance with the present disclosure. The polymer composition, for instance, can be used to produce automotive part 50, which comprises at least a portion of an interior door handle. The polymer composition may also be used to produce a part on the steering column, such as automotive part 60. In general, the polymer composition can be used to mold any suitable decorative trim piece or bezel, such as trim piece 70. In addition, the polymer composition can be used to produce knobs or handles that may be used on the interior of the vehicle.

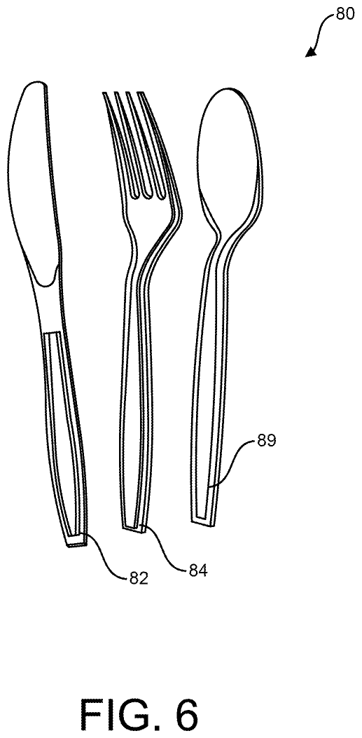

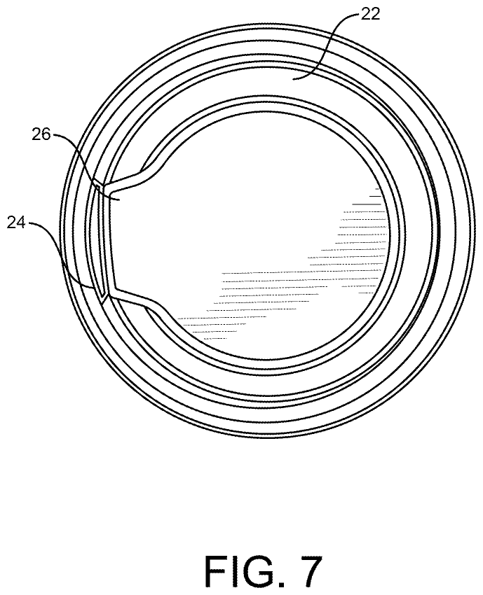

The polymer composition is also well suited to producing cutlery, such as forks, spoons, and knives. For example, referring to FIG. 6, disposable cutlery 80 is shown. The cutlery 80 includes a knife 82, a fork 84, and a spoon 86.

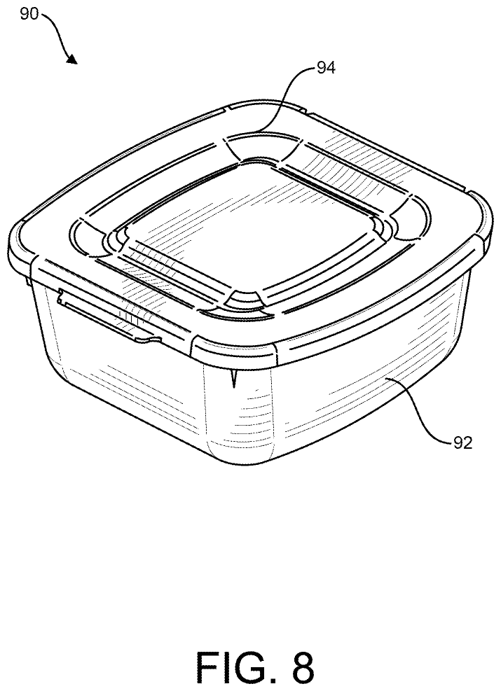

In still another embodiment, the polymer composition can be used to produce a storage container 90 as shown in FIG. 8. The storage container 90 can include a lid 94 that cooperates and engages the rim of a bottom 92. The bottom 92 can define an interior volume for holding items. The container 90 can be used to hold food items or dry goods.

In still other embodiments, the polymer composition can be formulated to produce paper plate liners, eyeglass frames, screwdriver handles, or any other suitable part.

The cellulose ester composition of the present disclosure is also particularly well-suited for use in producing medical devices including all different types of medical instruments. The cellulose ester composition, for instance, is well suited to replacing other polymers used in the past, such as polycarbonate polymers. Not only is the cellulose ester composition of the present disclosure biodegradable, but the composition has a unique “warm touch” feel when handled. Thus, the composition is particularly well suited for constructing housings for medical devices. When held or grasped, for instance, the polymer composition retains heat and makes the device or instrument feel warmer than devices made from other materials in the past. The sensation is particularly soothing and comforting to those in need of medical assistance and can also provide benefits to medical providers. In one aspect, the cellulose ester composition used to produce housings for medical devices includes a cellulose ester polymer combined with a plasticizer (e.g. triacetin) and optionally another bio-based polymer. In addition, the composition can contain one or more coloring agents.

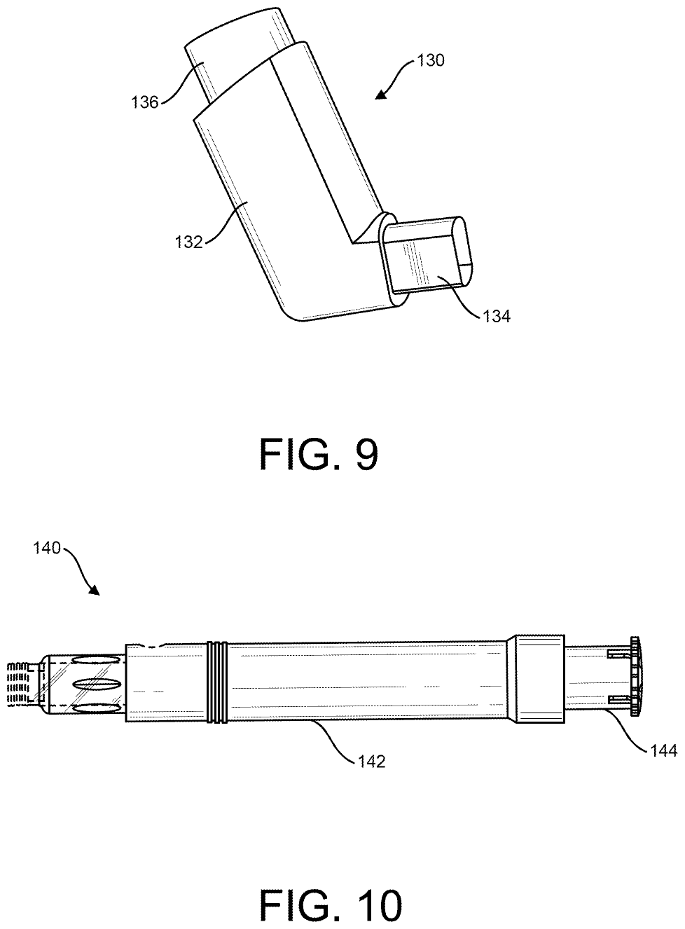

Referring to FIG. 9, for instance, an inhaler 130 is shown that may be made from the cellulose ester polymer composition. The inhaler 130 includes a housing 132 attached to a mouthpiece 134. In operative association with the housing 132 is a plunger 136 for receiving a canister containing a composition to be inhaled. The composition may comprise a spray or a powder.

During use, the inhaler 130 administers metered doses of a medication, such as an asthma medication to a patient. The asthma medication may be suspended or dissolved in a propellant or may be contained in a powder. When a patient actuates the inhaler to breathe in the medication, a valve opens allowing the medication to exit the mouthpiece. In accordance with the present disclosure, the housing 132, the mouthpiece 134 and the plunger 136 can all be made from a polymer composition as described above.

Referring to FIG. 10, another medical product that may be made in accordance with the present disclosure is shown. In FIG. 10, a medical injector 140 is illustrated. The medical injector 140 includes a housing 142 in operative association with a plunger 144. The housing 142 may slide relative to the plunger 144. The medical injector 140 may be spring loaded. The medical injector is for injecting a drug into a patient typically into the thigh or the buttocks. The medical injector can be needleless or may contain a needle. When containing a needle, the needle tip is typically shielded within the housing prior to injection. Needleless injectors, on the other hand, can contain a cylinder of pressurized gas that propels a medication through the skin without the use of a needle. In accordance with the present disclosure, the housing 142 and/or the plunger 144 can be made from a polymer composition as described above.

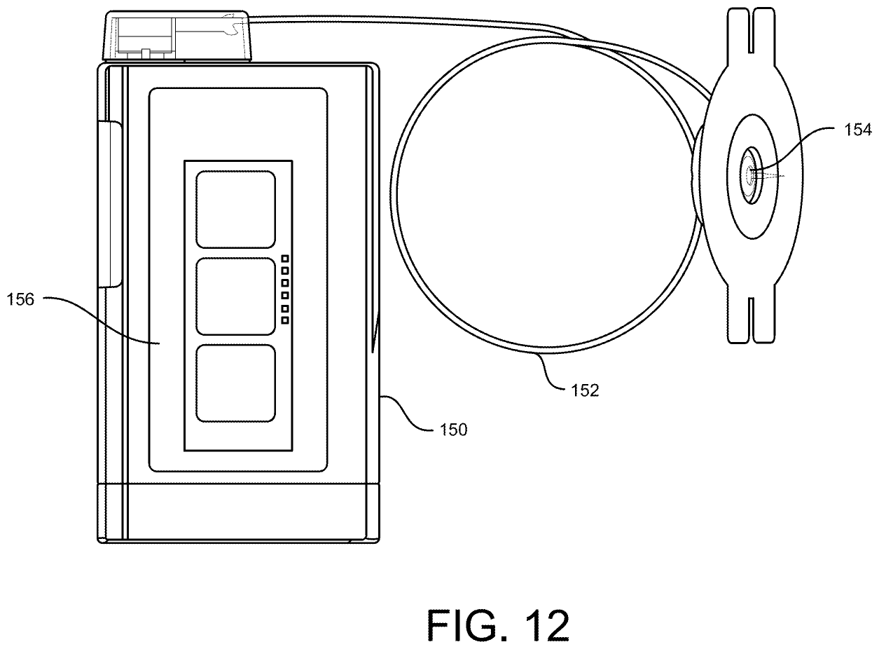

The medical injector 140 as shown in FIG. 10 can be used to inject insulin. Referring to FIG. 12, an insulin pump device 150 is illustrated that can include a housing 156 also made from the polymer composition of the present disclosure. The insulin pump device 150 can include a pump in fluid communication with tubing 152 and a needle 154 for subcutaneously injecting insulin into a patient.

The polymer composition of the present disclosure can also be used in all different types of laparoscopic devices. Laparoscopic surgery refers to surgical procedures that are performed through an existing opening in the body or through one or multiple small incisions. Laparoscopic devices include different types of laparoscopes, needle drivers, trocars, bowel graspers, rhinolaryngoscopes and the like.

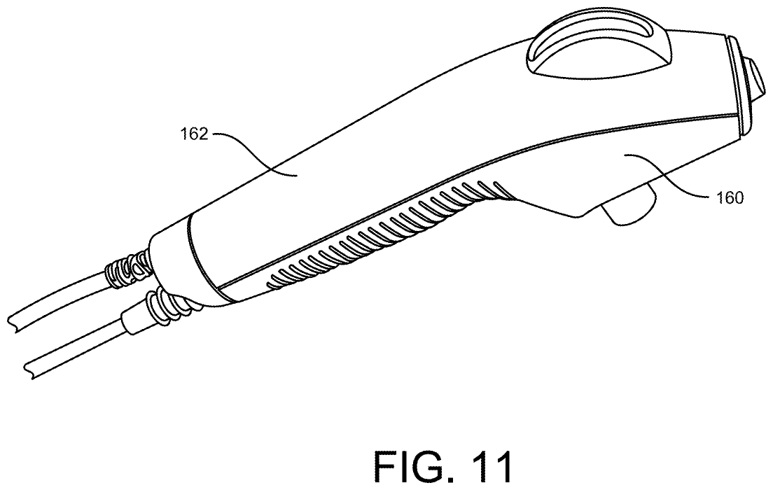

Referring to FIG. 11, for example, a rhinolaryngoscope 160 made in accordance with the present disclosure is shown. The rhinolaryngoscope 160 includes small, flexible plastic tubes with fiberoptics for viewing airways. The rhinolaryngoscope can be attached to a television camera to provide a permanent record of an examination. The rhinolaryngoscope 160 includes a housing 162 made from the polymer composition of the present disclosure. The rhinolaryngoscope 160 is for examining the nose and throat. With a rhinolaryngoscope, a doctor can examine most of the inside of the nose, the eustachian tube openings, the adenoids, the throat, and the vocal cords.

As described above, molded articles can be injection molded or thermoformed. When thermoformed, the polymer composition can be first formed into a film and then thermoformed into an article.

During thermoforming, the film substrate is heated and then manipulated into a desired three-dimensional shape. The substrate can be formed over a male mold or a female mold. There are two main types of thermoforming typically referred to as vacuum forming or pressure forming. Both types of thermoforming use heat and pressure in order to form a film substrate into its final shape. During vacuum forming, a film substrate is placed over a mold and vacuum is used to manipulate it into a three-dimensional article. During pressure forming, pressure optionally in combination with vacuum forces are used to mold the film substrate into a shape.

The use of thermoforming to produce three-dimensional articles has various advantages. For instance, thermoforming allows for the production of all different types of shapes with fast turnaround times. Modifications to designs can also occur quickly and efficiently. Thermoforming can also be cost effective and can produce articles having an aesthetic appearance.

The temperature and pressure to which the foam substrate is subjected during the thermoforming process can vary depending upon various different factors including the thickness of the foam substrate and the type of product being formed. In general, thermoforming may be conducted at a temperature of from about 75° to about 120°, such as from about 75° to about 100°. Higher temperatures, however, can also be used. As described above, the foam substrate is also subjected to pressure and/or suction forces that press the foam substrate against a mold for conforming the foam substrate to the shape of the mold. Once molded, the three-dimensional article can be trimmed and/or polished as desired.

As indicated above, the one or more salt additives combined with the cellulose ester polymer can dramatically reduce the melt flow rate of the resulting polymer composition. In addition to improving the melt processing characteristics of the polymer composition, inclusion of the salt additive can also increase tensile strength, increase modulus, and may also increase the deflection temperature of the composition. It is believed that the use of one or more salt additives in the polymer composition can also improve the appearance of molded articles made from the polymer composition.

In one aspect, an improvement in surface properties can be ascertained by a decrease in luminosity (L*). For instance, the salt additive can be combined with a cellulose ester polymer such that the resulting composition has an L* value that is less than the L* value of the same composition without the salt additive and with the cellulose ester polymer in the same amount. For example, the L* value can decrease by greater than about 0.1%, such as greater than about 0.3%, such as greater than about 0.5%, such as greater than about 0.8%, such as greater than about 1%.

As used herein, CIELab color values L*, a*, and b* are measured according to the color space specified by the International Commission on Illumination. The L*a*b* colourimetric system was standardized in 1976 by Commission Internationale de l'Eclairage (CIE). The CIELab L* value, utilized herein to define the darkness/lightness of the polymer composition, is a unit of colour measurement in the afore-mentioned CIELab system. A colour may be matched according to CIELab. In the L*a*b* colourimetric system, L* refers to lightness expressed by a numerical value.

Molded articles made according to the present disclosure can also have excellent clarity characteristics. The polymer composition of the present disclosure, for instance, can display low haze characteristics. For instance, the polymer composition exhibits a haze of less than about 50%, such as less than about 35%, such as less than about 25%, such as less than about 20%, such as less than about 15%, such as less than about 10%, such as less than about 8%, such as less than about 5%, such as less than about 3%, such as less than about 2%, such as less than about 1%, such as less than about 0.8%, such as less than about 0.5%, such as less than about 0.4%, such as less than about 0.3%, such as less than about 0.2%. Generally, Polymer articles made according to the present disclosure can be measured for haze according to ASTM Test D1003 (2013). Haze can be measured using any acceptable instrument according to the ASTM Test including, for instance, a BYK Gardner Haze-Gard 4725 instrument. Haze can be measured on a test plaque, on a film made according to the present disclosure, or on the final thermoformed article. The test plaque can have any suitable thickness, such as 1 mm, 2 mm, 3 mm, or 4 mm.

The present disclosure may be better understood with reference to the following example.

### Example No. 1

A cellulose ester polymer was combined with a plasticizer and different amounts of calcium acetate in accordance with the present disclosure and tested for melt flow rate. Each sample contained a cellulose ester polymer having an acetyl value of about 52.6 and an intrinsic viscosity of 1.65 dL/g. Each sample contained triacetin in an amount of 24% by weight as the plasticizer. The following samples were formulated:

| | Amount of Calcium Acetate |
|---|---|
| Sample No. | (ppm) |
| 1 | 0 |
| 2 | 200 |
| 3 | 600 |

The above compositions were extruded into pellets and then tested for melt flow rate. The temperatures during extrusion were varied. Melt flow rate was tested at 210° C. and at a load of 2.16 kg. The following results were obtained:

| | Melt Flow | Melt Flow | Melt Flow |
|---|---|---|---|
| Extrusion | Rate of | Rate of | Rate of |
| Temperatures | Sample No. 1 | Sample No. 2 | Sample No. 3 |
| (° C.) | (g/10 min) | (g/10 min) | (g/10 min) |
| 190/205 | 27.37 | 6.27 | 2.24 |
| 195/205 | 24.04 | 5.04 | 1.72 |
| 200/205 | 44.93 | 3.73 | 1.62 |
| 205/210 | 47.82 | 6.15 | 1.20 |

As shown above, adding small amounts of the salt additive dramatically and unexpectedly reduced the melt flow index in a way to facilitate melt processing of the composition.

### Example No. 2

The cellulose ester polymer described in Example No. 1, in flake form, was washed with water, calcium acetate solutions, and magnesium acetate solutions. The flakes were then subjected to thermogravimetric analysis (TGA) using ISO Test 11358. The following results were obtained:

| Sample | Elemental solution impregnation | | | | 250° C. | | 220° C. | |
|---|---|---|---|---|---|---|---|---|
| No. | Sample Description | Mg | Ca | SO4 | H2O % | Wt-loss % | H2O % | Wt-Loss % |
| 1 | Flake As is | 34.1 | 171.1 | 617.7 | 2.096 | 8.249 | 2.24 | 1.152 |
| 2 | Water Wash | 92.7 | 16.4 | 322.4 | 2.283 | 6.125 | 2.343 | 0.7589 |
| 3 | CaAc 72 ppm | 100.8 | 60.8 | 350.2 | 2.553 | 2.804 | 2.696 | 0.7558 |
| 4 | CaAc 144 ppm | 92.9 | 93.1 | 331.6 | 2.436 | 2.468 | 2.326 | 0.7602 |
| 5 | MgAc 1200 ppm | 324.2 | 18.7 | 377.2 | 2.514 | 3.533 | 2.387 | 1.176 |
| 6 | MgAc 2400 ppm | 492.2 | 16.7 | 407.3 | 2.599 | 4.16 | 2.649 | 1.195 |

The cellulose ester polymer washed with a salt additive in accordance with the present disclosure demonstrated a preserved molecular weight or an increased molecular weight even after a TGA test at 220° C. for 30 minutes.

The above samples were also subjected to gel permeation chromatography (GPC) after heating to 220° C. for 30 minutes. The following results were obtained:

| | Mn | Mp | Mw | Mz | |
|---|---|---|---|---|---|
| Sample No. | (kDa) | (kDa) | (kDa) | (kDa) | (Mw/Mn) |
| 1 | 24.5 | 21.1 | 66.4 | 275.8 | 2.712 |
| 2 | 29 | 30.6 | 55.5 | 205.2 | 1.909 |
| 3 | 37 | 52.9 | 93 | 267.2 | 2.515 |
| 4 | 44.4 | 63.3 | 115.4 | 340.5 | 2.597 |
| 5 | 56.4 | 72.1 | 146.7 | 428.6 | 2.602 |
| 6 | 58.3 | 73.3 | 149.9 | 427.3 | 2.573 |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed:

1. A polymer composition comprising:
a cellulose ester polymer, the cellulose ester polymer being present in the composition in an amount greater than about 40% by weight, the cellulose ester polymer having an acetyl value of from about 48% to about 56%;
a plasticizer; and
a salt additive, the salt additive being present in an amount sufficient to lower a melt flow rate of the polymer composition by greater than about 20% in comparison to an identical polymer composition not containing the salt additive.

2. A polymer composition as defined in claim 1, wherein the salt additive contributes cationic ions to the polymer composition.

3. A polymer composition as defined in claim 1, wherein the salt additive is present in the polymer composition in an amount sufficient to lower the melt flow rate of the composition by greater than about 30%.

4. A polymer composition as defined in claim 1, wherein the melt flow rate of the polymer composition is less than about 20 g/10 min, when tested at 210° C. and at a load of 2.16 kg.

5. A polymer composition as defined in claim 1, wherein the salt additive causes ionic crosslinking of the cellulose ester polymer.

6. A polymer composition as defined in claim 1, wherein the salt additive is present in the polymer composition in an amount from about 1 ppm to about 10,000 ppm.

7. A polymer composition as defined in claim 1, wherein the salt additive comprises a metal salt.

8. A polymer composition as defined in claim 1, wherein the salt additive comprises a salt with a multivalent cation.

9. A polymer composition as defined in claim 1, wherein the salt additive comprises a calcium salt, a magnesium salt, an iron salt, an aluminum salt, a zinc salt, a cobalt salt, a manganese salt, or mixtures thereof.

10. A polymer composition as defined in claim 1, wherein the salt additive comprises calcium acetate, magnesium acetate, calcium hydroxide, ferrous acetate, ferric acetate, zinc acetate, cobalt acetate, manganese acetate, magnesium hydroxide, calcium sulfate, calcium bicarbonate, calcium bromide, calcium chloride, calcium nitrate, calcium perchlorate, calcium propionate, calcium benzoate, magnesium bromide, magnesium chlorate, magnesium nitrate, magnesium perchlorate, magnesium sulfate, magnesium thiosulfate, calcium citrate, calcium gluconate, calcium lactate, zinc acetate, cobalt acetate, manganese acetate, lime, or mixtures thereof.

11. A polymer composition as defined in claim 1, wherein the cellulose ester polymer has an acetyl value of greater than 50% and lower than 54%.

12. A polymer composition as defined in claim 1, wherein the salt additive is present in the composition in an amount sufficient to lower an L* value of an article formed from the polymer composition.

13. A polymer composition as defined in claim 1, wherein the cellulose ester polymer is present in the polymer composition in an amount from about 55% by weight to about 95% by weight, and the plasticizer is present in an amount from about 5% by weight to about 40% by weight.

14. A polymer composition as defined in claim 1, wherein the plasticizer comprises tris(clorisopropyl) phosphate, tris(2-chloro-1-methylethyl) phosphate, glycerin, monoacetin, triethyl citrate, acetyl triethyl citrate, a phthalate, an adipate, polyethylene glycol, triacetin, diacetin, trimethyl phosphate, triethyl phosphate, tributyl phosphate, triphenyl phosphate, tributyl-o-acetyl citrate, dibutyl tartrate, ethyl o-benzoylbenzoate, n-ethyltoluenesulfonamide, o-cresyl p-toluenesulfonate, aromatic diol, a substituted aromatic diol, an aromatic ether, tripropionin, tribenzoin, glycerin esters, glycerol tribenzoate, glycerol acetate benzoate, polyethylene glycol, a polyethylene glycol ester, a polyethylene glycol diester, di-2-ethylhexyl polyethylene glycol ester, a glycerol ester, diethylene glycol, polypropylene glycol, a polyglycoldiglycidyl ether, dimethyl sulfoxide, N-methyl pyrollidinone, propylene carbonate, a C1-C20 dicarboxylic acid ester, di-butyl maleate, di-octyl maleate, resorcinol monoacetate, catechol, catechol esters, phenols, epoxidized soy bean oil, castor oil, linseed oil, epoxidized linseed oil, difunctional glycidyl ether based on polyethylene glycol, an alkyl lactone, a phospholipid, 2-phenoxyethanol, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, glyceryl tribenzoate, neopentyl dibenzoate, triethylene glycol dibenzoate, trimethylolethane tribenzoate, butylated hydroxytoluene, butylated hydroxyanisol, sorbitol, xylitol, ethylene diamine, piperidine, piperazine, hexamethylene diamine, triazine, triazole, pyrrole, polycaprolactone diol and mixtures thereof.

15. A polymer composition as defined in claim 1, wherein the plasticizer comprises triacetin, polyethylene glycol, or mixtures thereof.

16. A polymer composition as defined in claim 1, wherein the cellulose acetate consists essentially of cellulose diacetate.

17. An article made from the polymer composition as defined in claim 1.

18. An article as defined in claim 17, wherein the article has been formed through injection molding or extrusion.

19. An article as defined in claim 17, wherein the article is a beverage holder, a drinking straw, a hot beverage pod, a fork, a knife, a spoon, packaging, a container, a lid, or an interior automotive part.

20. A polymer composition comprising:
a cellulose ester polymer, the cellulose ester polymer being present in the composition in an amount greater than about 40% by weight, the cellulose ester polymer having an acetyl value of from about 48% to about 56%;
a plasticizer, the plasticizer being present in the polymer composition in an amount from about 12% by weight to about 35% by weight; and
a salt additive that contributes cationic ions to the polymer composition, and wherein the polymer composition has a melt flow index of less than 20 g/10 min when tested at 210° C. and at a load of 2.16 kg.

21. A polymer composition comprising:
a cellulose ester polymer, the cellulose ester polymer being present in the composition in an amount greater than about 40% by weight;
a plasticizer; and
a salt additive that contributes cationic ions to the polymer composition, the salt additive being present in an amount sufficient to lower a melt flow rate of the polymer composition by greater than about 20% in comparison to an identical polymer composition not containing the salt additive.
